(19) United States
(12) Patent Application Publication
(10) Pub. No.: US 2013/0133221 A1
(43) Pub. Date: May 30, 2013

(54) PROCESS FOR CONTROLLING DRYER CAPABLE OF DEHUMIDIFYING AIR ENTERING THE OIL EXPANSION VESSELS USED IN ELECTRICAL APPLIANCES

(71) Applicants: Carlo Carollo, Zugliano (VI) (IT); Andrea Tonnin, Brogliano (VI) (IT)

(72) Inventors: Carlo Carollo, Zugliano (VI) (IT); Andrea Tonnin, Brogliano (VI) (IT)

(73) Assignee: ABB TECHNOLOGY AG, Zurich (CH)

(21) Appl. No.: 13/578,072

(22) PCT Filed: Feb. 10, 2011
(86) PCT No.: PCT/IT11/00035

§ 371 Date: Oct. 16, 2012

(30) Foreign Application Priority Data
Feb. 12, 2010 (IT) VI20100A000031

(51) Int. Cl. F26B 7/00

(52) U.S. Cl. CPC F26B 7/00
USPC 34/469; 34/73

(57) ABSTRACT

Process for controlling a dryer, suitable of dehumidifying air entering oil expansion vessels used in electrical appliances, in which a protective casing of the dryer surrounds at least two dehumidifying tanks or vessels containing an absorption device suitable to absorb air humidity coming from the outside and which can be thermally regenerated by resistors. The resistors are connected with a load cell, suitable to determine the state of saturation of the absorption device, so that detecting by the load cell of a measured mass value greater than a predefined threshold value (MFS) operates the resistors in order to regenerate the absorption device to the original state.

The present invention, in general, refers to a process for controlling a dryer capable of dehumidifying air entering the oil expansion vessels used in electrical appliances, and, in particular, oil-insulated electrical appliances, such as for instance power transformers, loaded switches, etc,; the invention also concerns the dryer used in such a control process.

An electrical appliance containing insulating oil usually includes an oil expansion vessel which has the function of offsetting the inevitable volume changes of oil that create inside the appliance due to sudden changes in temperature; such an oil expansion vessel is supplied with air previously treated in a special dryer so as to eliminate or drastically reduce its humidity, in order to measure the correct values of the breakdown voltage of the insulating oil.

Prior patent document WO 2005/055255 discloses a dryer front of known type, in which a dehumidifying tank has an inlet for the air to be dehumidified and an outlet for dehumidified air and absorption means, consisting of a plurality of granules or salts that can be thermally regenerated and suitable to dehumidify air coming from outside, are present inside the dehumidifying tank.

The dryer also includes a resistor, intended for the thermal regeneration of the absorption means, and at least one humidity sensor, suitable to detect the value of residual humidity in the dry air and cause the operation of the resistor if such a humidity value exceeds a predefined maximum value.

The aforesaid patent document WO 2005/055255 also discloses an operative method for the functioning of the dryer, whereby the resistor suitable to thermally regenerate the absorption granules or salts is operated when the predefined limit value of humidity is exceeded and further when no flow of air entering the oil expansion tank is detected; in other words, according to this method of functioning of the dryer, the resistor is operated only when no flow of air entering the tank oil expansion is detected, or when the air comes out from the aforesaid oil expansion tank.

However, according to this operative method of functioning, no. activation of the resistor occurs when the air flows inside the oil expansion tank, unless directional sensors are used, suitable to detect the air flow and/or its management, or pressure sensors, suitable to measure the pressure difference between the dehumidifying tank and oil expansion tank; however, such sensors have to allow very precise measures, since the typical values an air flow passing through an oil expansion tank are usually included between 0.5 and 2.5 l/min, and consequently they are very expensive.

Moreover, detection of humidity degree of the dry air does not always provide the complete regeneration of absorption means, because, sometimes, the incoming air into the dehumidifying tank follows preferential paths, this distorting the detection itself and having as consequence that the humidity sensor operates and deactivates with high frequency the resistor, with related inevitable reliability problems about of the aforesaid resistor caused by the continuous switching on and switching off cycles.

Purpose of the present invention is therefore to overcome the complained technical drawbacks and, in particular, to indicate a process for controlling a dryer, suitable to dehumidify air entering oil expansion vessels used in electrical appliances, which allows to avoid the use of directional sensors of the air flow and/or pressure sensors, while ensuring the proper functioning of the resistor used to regenerate the absorption means and operating such a resistor only if there is no air flow passing through the oil expansion vessel.

Another purpose of the present invention is to implement a process for controlling a dryer, suitable to dehumidify air entering oil expansion vessels used in electrical appliances, which is more reliable and efficient than equivalent process of known type.

Another purpose of the invention is to provide a process for controlling a dryer which allows to monitor the dehumidification state of the absorption means of the aforesaid dryer in a manner more effective than the known art, as well as to make available a dryer on which implementing said control process.

Further purpose of the invention is to indicate a process for controlling a dryer, suitable to dehumidify air entering oil expansion vessels used in electrical appliances, which allows a simplified and cheaper dryer construction, compared to the prior art.

These and other purposes are achieved through the implementation of a dryer, suitable to dehumidify air entering oil expansion vessels used in electrical appliances, according to the attached claim 1, and by a related control process, according to the appended claim 3.

Other technical features of detail of the control process and dryer, which are object of the present invention, are set forth in the respective dependent claims.

Advantageously, the control process according to the invention allows to perform accurate measured of the level of dehumidification of the absorption means and, indirectly, of the humidity degree of the just dehumidified air, while however keeping a high level of functional efficiency of the organs involved and, in particular, the heating means suitable to regenerate the abovementioned absorption means.

Still advantageously, the dryer on which the control process object of the invention is implemented is of simple construction and provides for low costs, compared to the prior art.

The above mentioned purposes and advantages will appear better evident from the description that follows, referring to a preferred embodiment of the invention and given by illustrative, but not limited, way of example with the help of the attached drawings, where:

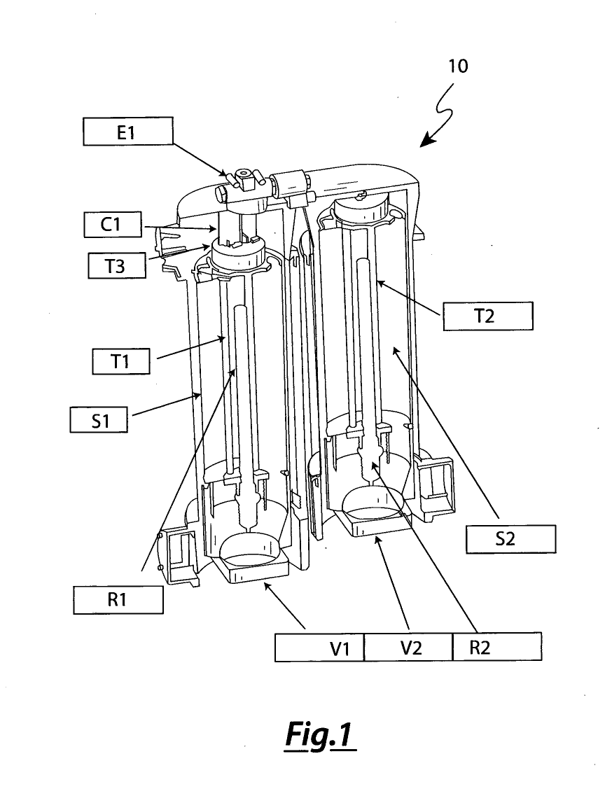

FIG. 1 is a schematic section view of a dryer, suitable to dehumidify air entering oil expansion vessels used in electrical appliances and operating according to the control process of the present invention;

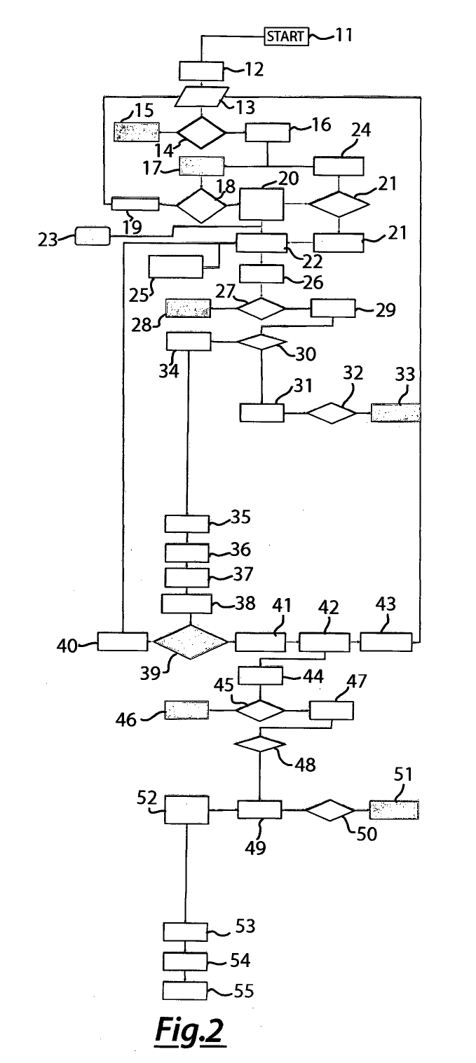

FIG. 2 shows an outline block diagram of the control process of a dryer, suitable to dehumidify air entering oil expansion vessels used in electrical appliances, according to the invention.

With particular reference to the mentioned FIG. 1, a dryer suitable to dehumidify air entering oil expansion vessels used in electrical appliances, is generically indicated with 10 and basically comprises two dehumidifying vessels or tanks S1, S2, each of which presents a series of micro-openings for entering the air to be dehumidified and an opening for outgoing the dehumidified air and contains absorption means, such as salts or salty granules, suitable to absorb humidity of air coming from the outside and which can be thermally regenerated.

Ventilation means, such as the fans V1 and V2, and heating means, such as resistors R1 and R2, are also provided, placed respectively inside the dehumidifying tanks S1 and S2 and suitable to regenerate the absorption means, as well as detection means, operatively connected with the heating means R1, R2 and suitable to determine the state of saturation of the salts contained into the tanks S1, S2.

In preferred and illustrative, but not limited, way, the detection means includes a transducer coupled with the dehumidifying tank S1 through fastening means of traditional type, which directly measures the degree of dehumidification of the absorption means contained into the tank S1.

In particular, the transducer consists, as preferably, of an electronic load cell C1, electrically connected with the electric energy power system, of the compression type (converting a force applied into an electrical resistance change) or traction type (converting a stretch into an electrical resistance change).

The dryer 10 also comprises an outer protective casing surrounding the dehumidifying tanks S1, S2 and provided with locking flanges, where the openings for outgoing the dehumidified air are made, and one or more sumps for collecting, conveying and discharging outside condensate which leaks, during use, from the inlet micro-openings of the tanks S1, S2.

The collection sump is also provided of an outlet suitable to discharge condensate outside and into which a filtering body is inserted, which is then crossed, in a direction, by the air to be dehumidified entering the tanks S1, S2, and, in the opposite direction, by the condensate to be discharged that is produced, during operation, in the tanks S1, S2.

Detection by the load cell C1 of a measured mass value M greater than a predefined maximum threshold value Mfs means that the absorption means contained into the tanks S1, S2 have reached a predetermined saturation level and, therefore, resistors R1, R2 are operated in order to regenerate the aforesaid absorption means (salts) to the original state.

Condensate produced at this stage leaks out from the inlet micro-openings of the side walls of the tanks S1, S2 and reaches the collection sumps, from which it is conveyed outside.

According to the invention, three resistance temperature detectors (RTD) T1, T2, T3 are also used, consisting of respective temperature sensors placed,, respectively, inside the tank S1, inside the tank S2 and inside the cell room C1.

With particular reference to the attached FIG. 2, the control process, which is the object of the invention, as from a starting phase 11 and a setting at zero phase 12 of the data related to the load cell C1, performs a screening phase 13 of the temperature values detected by the resistance temperature detector T1 and resistance temperature detector T3 and of the mass value M detected and measured by the load cell C1 and a comparison 14 between the measured mass value M and full scale (maximum) value Mfs.

In case a condition according to which M>MFs is detected, a first alarm condition 15 occurs, while if M<Mfs (block 16) a further data processing (block 17) occurs with the calculation of the value of the parameter M (detected mass value) and comparison with the value Ms, which is a mass value prefixed by the load cell C1.

Comparing the values M and Ms (block 18), if M<Ms (block 19) the control process returns to the screening phase 13, while if M>Ms (block 20), for a predetermined time interval is (with Ms=Ms1 and Ms1 equal to the mass value of operation of the resistor R1), the process performs a check of the cycle of the tank S2 (block 21) and switching the electric valve E1 (block 22) in such a way as to operate the tank S2, after having driven an automatic start (block 23) of the resistor R1.

The switching of the electric valve El and consequent activation of the tank S2 occurs even if by checking the cycle of the tank S2 (block 21) it results that the resistor R2 or fan V2 is not operating, while if these components are operating (block 24) the control process gets back to the data processing phase of the block 17.

The operation phase of the heat cycle of the tank S1 (block 25) determines the operation of the resistor R1 (block 26) and check of such a resistor R1 (block 27) and, therefore, in case of negative check, operation of an alarm (block 28) and, in case of positive check (block 29), starting of a phase of analysis (block 30) of the resistance temperature detector T1 a phase of operation (block 31) and check (block 32) of the fan V1, which, in case of negative check, causes the operation of an another alarm (block 33).

The analysis phase of the resistance temperature detector T1 (block 30) goes on by putting the temperature value which can be detected by T1 equal to an initial value T1s, when the cycle of the resistor R1 is activated, increasing such a value of a prefixed amount of ° C./min (block 34), up to reach (block 35) a value T1s equal to a maximum value T1M of heat temperature of the tank S1 for a maintenance time t1m equal to a predetermined value (and equal, for example, to five hours), to a value T1s equal to 0 (block 36) and to a predetermined and settable value of temperature Y1 which can be detected by the resistance temperature detector T1, whereby the fan V1 is stopped (block 37).

In such a case, by detecting a pre-settable value Z of the difference between the temperature values which can be detected by the resistance temperature detector T1 and resistance temperature detector T3 (block 38), a phase of data processing T1, T3 and M (stage 39) is reached, whereby if M>Ms1 (block 40) the control process stars again from the switching phase of the electric valve E1 (block 22), while if M<Ms1 (block 41) a switching phase of the electric valve E1 takes place, which allows to operate the tank S1 (phase 42), and a phase of automatic setting at zero (block 43) of the load cell C1, with M=M0 and M0 equal to the mass M after setting at zero, which brings back the control process to the phase of screening of the parameters T1, T3 and M (block 13).

The phase of switching of the electric valve E1 and operation of the tank S1 (phase 42) causes the operation of the resistor R2 (phase 44) and a check phase (block 45) of the resistor R2, which, in case of negative outcome, determines the operation of an alarm (block 46), while, in case of positive outcome (block 47), determines a phase of analysis of the resistance temperature detector T2 (phase 48) and a phase of operation (phase 49) and check (phase 50) of the fan V2, which, in case of negative check, determines the activation of a related alarm (block 51).

The activation of the fan V2 (block 49) occurs for a temperature value T2s detected by T2 which can be set and increased of prefixed values of ° C./min (block 52) up to a maximum value T2M of heating temperature of the tank S2 (block 53) for a pre-established maximum maintaining time interval t2m (equal, for example, to five hours), as well as up to a temperature value T2S equal to 0 (block 54) and a predetermined settable temperature value Y2 which can be detected by the three Resistance Temperature Detector (RTD) T2 for which the fan V2 is stopped (block 55).

The features of the dryer, capable of dehumidifying air entering the oil expansion vessels used in electrical appliances, and related control process, as well as the advantages, are clear from the description made.

It is, finally, clear that several other variations may be made to the dryer and control process in question, without departing from the principle of novelty intrinsic in the inventive idea expressed here, as it is clear that, in the practical implementation of the invention, materials, shapes and sizes of the illustrated details can be changed, as needed, and replaced with others technically equivalent.

1. A dryer (10), suitable for dehumidifying air entering oil expansion vessels used in power electrical appliances, comprising at least one outer protective casing, provided with locking flanges, where openings for outgoing dehumidified air are provided, and at least one sump for collecting, conveying and discharging outside condensate, wherein said protective casing surrounds at least two dehumidifying tanks or vessels, each of which has a plurality of micro-openings for entering the air to be dehumidified and one or more openings for outgoing the dehumidified air and contains absorption means, suitable to absorb the humidity of air coming from outside and which can be thermally regenerated through resistors placed inside said dehumidifying tanks and connected with:
ventilation means of said tanks and
at least one load cell suitable to determine the saturation state of said absorption means contained into said dehumidifying tanks through the conversion of an applied force into an electrical resistance variation, in such a way that a detection by said load cell of a measured mass value (M) greater than a predefined threshold value (MS1) operates said resistors in order to regenerate said absorption means to the original state.

2. The dryer as claim 1, wherein respective temperature sensors are placed inside said dehumidifying tanks and inside said load cell.

3. A process for controlling a dryer suitable for dehumidifying air entering oil expansion vessels used in power electrical appliances, said dryer being made according to claim 2, wherein it comprises at least the following steps:
starting and setting at zero of data relating to said load cell;
first screening of temperature values detected by at least two of said temperature sensors and of said mass value (M) measured by said load cell;
comparison between said mass value (M) measured by said load cell and said predefined threshold value (Mfs);
sending of an alarm signal, in case said mass value (M) is greater than said predefined threshold value (Mfs);
data processing with the computation of at least one detected first mass value (M) and comparison with at least one prefixed second mass value (Ms), in case said mass value (M) is lower than said predefined threshold value (Mfs);
second screening of said temperature values, in case said first mass value (M) is lower than said prefixed second mass value (Ms);
checking of the cycle of at least one dehumidifying tank and switching on of at least one second dehumidifying tank and first resistors associated with at least one first dehumidifying tank, in case said first mass value (M) is greater than said prefixed second value (Ms) for a prefixed time limit (ts) and said first mass value (M) is greater than a mass value (Ms1) for which said first resistors of a previous cycle operates.

4. The process as claim 3, wherein switching on of said dehumidifying tanks takes place through at least one three-way electromagnetic valve.

5. The process as claim 3, wherein said first dehumidifying tank is switched on when second resistors and/or second ventilation means, associated with a second dehumidifying tank, are off.

6. The process as claim 5, wherein it goes back to said data processing step in case said second resistors and/or second ventilating means, associated with said second dehumidifying tank, are on.

7. The process as claim 3, wherein an alarm is activated in case of negative check of said first resistors which are associated with at least one first dehumidifying tank.

8. The process as claim 7, wherein starting a phase of analysis of at least one first temperature sensor, which is connected with said first dehumidifying tank, and a phase of switching on and testing of said first ventilating means associated with said first dehumidifying tank, in case of positive check of said first resistors.

9. The process as claim 8, wherein an alarm is activated in case of negative check of said first ventilating means associated with at least one first dehumidifying tank.

10. The process as claim 8, wherein said phase of analysis of said first temperature sensor provides for at least the following steps:
allocating an initial value of a heating temperature of said first dehumidifying tank to the temperature value which can be detected by said first temperature sensor, when a cycle of said first resistors is activated;
increasing said initial temperature value of a prefixed amount up to a value equal to a maximum value, for a maintenance time interval equal to a predetermined value, then to a value equal to zero and a further predetermined and settable temperature value which can be detected by said first temperature sensor and stops said first ventilating means.

11. The process as claim 10, wherein it includes the further following steps:
detecting a prefixed value (Z) equal to the difference between the temperature values which can be detected by said first temperature sensor and a third temperature sensor associated with said load cell;
processing of data coming from said first temperature sensor, said third temperature sensor and said load cell, according to which, if said mass value (M) is greater than said mass value (Ms1) for which said first resistors of a previous cycle operates, said process restarts from said switching on phase of said second dehumidifying tank, while, if said mass value (M) is lower than said mass value (Ms1) for which said first resistors of a previous cycle operates, said process provides for a switching phase, which allows to switch on said first dehumidifying tank, and an automatic setting at zero phase of said load cell, with said mass value (M) equal to said mass value after said setting at zero phase (M0), suitable to bring said process back to said first phase of screening of said temperature values and said mass value.

12. The process as claim 11, wherein said switching on phase of said first dehumidifying tank causes a further switching on and testing phase of said second resistors associated with said second dehumidifying tank.

13. The process as claim 12, wherein an alarm is activated in case of negative check of said testing phase of said second resistors.

14. The process as claim 12, wherein, if said testing phase of said second resistors has a positive check, it provides for analyzing said temperature sensor associated with said second dehumidifying tank and switching on and testing said second ventilating means associated with said second dehumidifying tank.

15. The process as claim 14, wherein an alarm is activated in case of negative check of said testing phase of said second ventilating means.

16. The process as claim 14, wherein said second ventilating means are switched on when said temperature sensor, associated with said second dehumidifying tank, detects a prefixed value of heating temperature of said second dehumidifying tank, said prefixed value being able to be incremented of predetermined ranges of value up to a maximum value of heating temperature of said second dehumidifying tank, for a pre-established maximum maintaining time interval, and up to a value of said heating temperature equal to zero and/or equal to a predetermined and settable value of said heating temperature, which can be detected by said temperature sensor associated with said second dehumidifying tank, such that said second ventilating means are switched off.
